(19) United States
(12) Patent Application Publication
(10) Pub. No.: US 2016/0140337 A1
(43) Pub. Date: May 19, 2016

(54) System to Create Mobile Digital Identifier

(71) Applicant: International Business Machines Corporation, Armonk, NY (US)

(72) Inventor: Richard Redpath, Cary, NC (US)

(73) Assignee: International Business Machines Corporation, Armonk, NY (US)

(21) Appl. No.: 14/546,091

(22) Filed: Nov. 18, 2014

(51) Int. Cl. G06F 21/46; G06F 21/36

(52) U.S. Cl. CPC G06F 21/46; G06F 21/36

(57) ABSTRACT

A method, system and computer-usable medium are disclosed for producing a digital identifier. A set of design elements are selected for inclusion in the digital identifier, followed by the selection of an associated digital identifier template and a set of user credentials. The selected design elements, template and user credentials are then used to produce the digital identifier.

### BACKGROUND OF THE INVENTION

1. Field of the Invention

The present invention relates in general to the field of computers and similar technologies, and in particular to software utilized in this field. Still more particularly, it relates to a method, system and computer-usable medium for producing a digital identifier.

2. Description of the Related Art

Personal identification documents are commonly used for a variety of purposes, such as licenses, registration cards, and membership cards. As such, they need to be safe, authentic, secure and accurate to properly identify and verify various aspects of a person's identity. These aspects may include the bearer's full name, age, birth date, address, one or more identification numbers, an expiry date or other related information, permissions and restrictions, profession or rank, religion, ethnic or racial classification, citizenship status, and so forth.

Other identity aspects may include graphical elements, such as a portrait photo of the bearer, a digitized image of their signature, or various types of bar codes, which may contain a variety of digitally-encoded information. It has also become common in recent years to embed other graphical elements in identity documents, such as a governmental or organization seal, a security guilloche, a holographic image, or various combinations thereof to provide additional proof of authenticity. These embedded graphical elements also make it more difficult to counterfeit or alter the identification document.

Today, many identification documents are issued in the form of paper or plastic cards that conform to generally standardized formats and form factors. It has also become increasingly popular to embed a computer chip in plastic-based cards that are used to electronically communicate digitally-encoded information related to the bearer of the identification document. However, the expense of adding these additional features may be prohibitive to government agencies, companies, and other organizations that need to manage the lifecycle of the identification documents they issue in a cost-effective manner. Furthermore, our society is increasingly becoming more digital and more mobile. As a result, many users would prefer to carry fewer physical documents.

### SUMMARY OF THE INVENTION

A method, system and computer-usable medium are disclosed for producing a digital identifier such as a digital license card. In various embodiments, a set of design elements are selected for inclusion in the digital identifier, followed by the selection of an associated digital identifier template and a set of user credentials. The selected design elements, template and user credentials are then used to produce the digital identifier.

In certain of these embodiments, the design elements may include a set of graphical design elements and a set of textual design elements and the digital identifier may be secured to prevent unauthorized access. In various embodiments, the set of graphical design elements may include a digitized photograph of an individual associated with the digital identifier, a digitized signature of an individual associated with the digital identifier, a digitized glyph, a digitized barcode, a digitized security guilloche, and a digitized background image. In certain embodiments, one or more of the graphical design elements may be captured by a user device, such as a mobile device.

In various embodiments, the set of textual design elements may include the name of the individual, the address of the individual, and the employee identifier (ID) of the individual. In certain embodiments, the set of textual design elements may also include a list of privileges associated with the individual, and the issuance date, issuance time, expiry date, and expiry time of the digital identifier. In various embodiments, the design elements may be either supplied or customized by the user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of a digital identifier system;

FIG. 3 depicts a digital identifier template used to generate a privately-issued digital identifier;

FIG. 4 depicts a digital identifier template used to generate a government-issued digital identifier;

FIG. 5 shows vertical and horizontal formats of a government-issued digital identifier;

FIG. 6 shows the front and back aspects of a two-sided, government-issued digital identifier;

FIG. 7 is a generalized flowchart of the performance of operations to create a digital identifier template; and

FIG. 8 is a generalized flowchart of the performance of digital identifier service operations.

### DETAILED DESCRIPTION

A method, system and computer-usable medium are disclosed for producing a digital identifier such as a digital license card. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

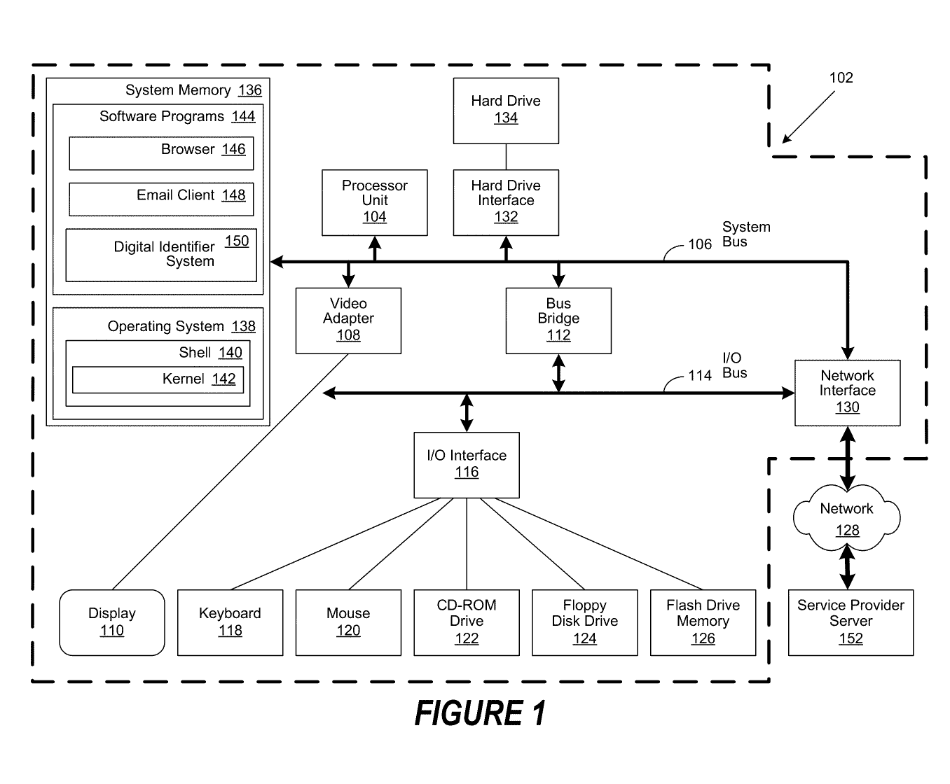

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include a digital identifier system 150. In these and other embodiments, the digital identifier system 150 includes code for implementing the processes described herein below. In one embodiment, client computer 102 is able to download the digital identifier system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

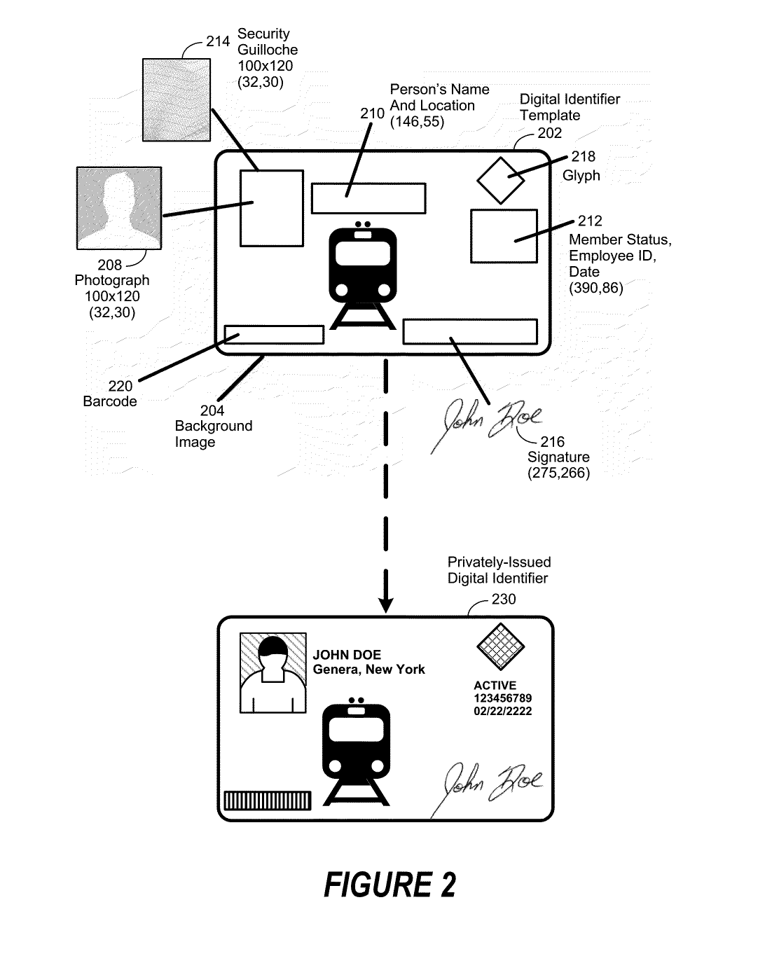

FIG. 2 depicts a digital identifier template designed in accordance with an embodiment of the invention to generate a privately-issued digital identifier. In various embodiments, a digital identifier template is used to generate an associated instance of a digital identifier. In these embodiments, as described in greater detail herein, a user of a mobile device accesses a digital identifier system, selects a digital identifier template associated with the digital identifier they wish to receive, and provides personal identification information. In certain embodiments, the personal identification information may include one or more authentication factors, a digitized photographic image of the user, a digitized image of their signature, or a combination thereof. The personal identification information is then processed along with the previously selected digital license template to generate an associated instance of a digital identifier, which in turn is provided to the user's mobile device.

In this embodiment, a unique name or identifier (e.g., “Amtrak Reward”) is selected for a digital identifier template 202 that will be used to generate an associated instance of a privately-issued digital identifier 230. The design of the digital identifier template 202 is then defined by specifying the type, size, and placement of individual digital identifier design elements. In various embodiments, these individual digital identifier design elements may include graphical elements, such as a digitized background image 204, a digitized photographic image of the individual 208, a digitized glyph 218, a digitized barcode 220, a digitized security guilloche 214, and a digitized image of the individual's signature 216. In certain embodiments, the digitized barcode 220 may be implemented in the privately-issued digital identifier as a security feature. In various embodiments, the digitized barcode may be a PDF417, code128, or other type of barcode. Likewise, the individual digital identifier design elements may include textual elements, such as the individual's name and location 210, and their member status, employee ID, and date 212. Likewise, some or all of the digital identifier design elements may be secured by any of a plurality of security methods so as to prevent unauthorized access to the digital identifier.

As used herein, a digitized security guilloche broadly refers to an intricate, repetitive pattern or design of intersecting or overlapping spirals or other shapes, which is implemented in combination with one or more digital identifier design elements to reduce the possibility of forgery, tampering, or counterfeiting. As an example, the digitized security guilloche 214 is implemented in combination with a digitized photographic image 208 of the individual. More particularly, the size (100×120) and the position (32, 30) of the digitized security guilloche 214 and the digitized photographic image 208 are the same, resulting in the two graphical elements being superimposed upon one another. In various embodiments, the position of the individual identifier design elements are defined through the implementation of the Scalable Vector Graphics (SVG) format. Skilled practitioners of the art will be familiar with SVG, which is an Extensible Mark-up Language (XML) based vector image format for two-dimensional graphics with support for interactivity and animation. As an example, the position of the digitized photographic image of the individual 208, digitized security guilloche 214, digitized image of the individual's signature 216, the individual' name and location 210, and their member status, employee ID, and date 212, are respectively (32,30), (32, 30), (146,55), (390,86), and (275,266).

Once the digital identifier template 202 has been designed, a corresponding digital identifier configuration file is generated. In various embodiments, the digital identifier configuration file is generated in an XML format (e.g., amtrak.conf.xml) familiar to those of skill in the art. In these and other embodiments, the resulting digital license configuration file is then associated with a predetermined digital identifier service, as described in greater detail herein.

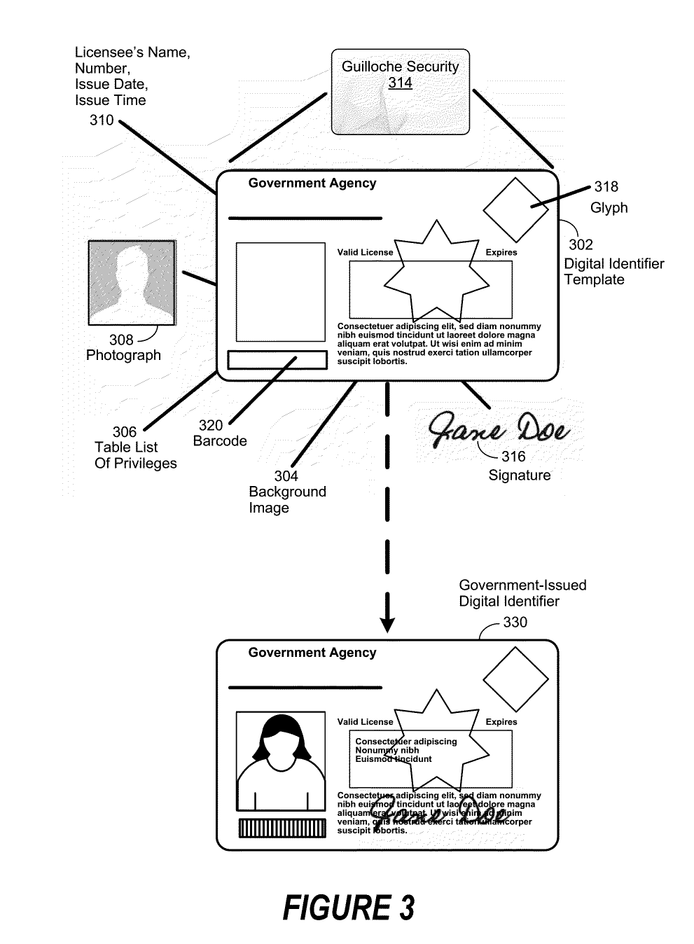

FIG. 3 depicts a digital identifier template designed in accordance with an embodiment of the invention to generate a government-issued digital identifier. In this embodiment, a unique name or identifier (e.g., “NC Fishing”) is selected for a digital identifier template 302 that will be used to generate an associated instance of a government-issued digital identifier 230. The design of the digital identifier template 302 is then defined by specifying the type, size, and placement of individual digital identifier design elements. In various embodiments, these individual digital identifier design elements may include graphical elements, such as a digitized background image 304, a digitized photographic image of the individual 308, a digitized glyph 318, a digitized barcode 320, a digitized security guilloche 314, and a digitized image of the individual's signature 316. Likewise, the individual identifier design elements may include textual elements, such as a table list of privileges 306, and the individual's name, number, and issue date and time 310.

Once the digital identifier template 302 has been designed, a corresponding digital identifier configuration file is generated. In various embodiments, the digital identifier configuration file is generated in an XML format (e.g., ncfishin.conf.xml) familiar to those of skill in the art. In these and other embodiments, the resulting digital license configuration file is then associated with a predetermined digital identifier service, as described in greater detail herein.

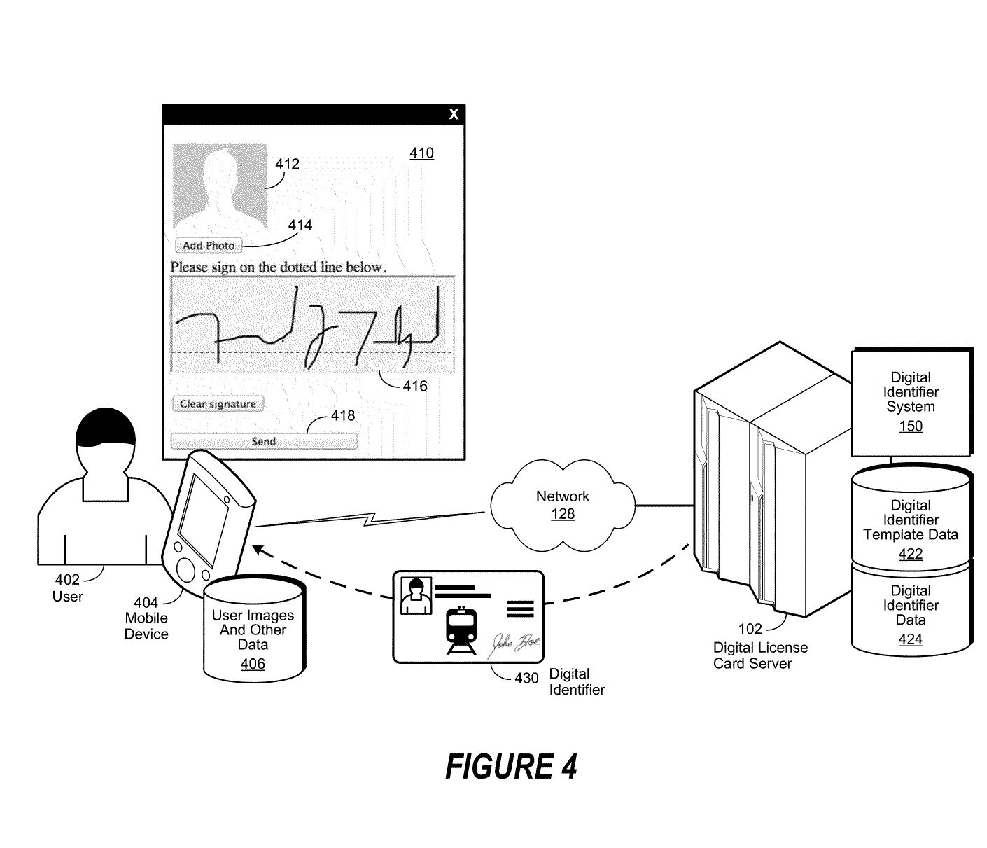

FIG. 4 is a simplified block diagram of a digital identifier system implemented in accordance with an embodiment of the invention. In various embodiments, a digital card license system 150 is implemented on a digital identifier server 102. In certain embodiments, the digital identifier server 102 also includes repositories of digital identifier template data 422 and digital card individual data 424. In these various embodiments, the repository of digital identifier template data 422 may be used store graphical elements, textual elements, and configuration files associated with various digital card license templates, such as those described in the descriptive text associated with FIG. 2 and FIG. 3. Likewise, the repository of digital card individual data 424 may be used to store data associated with individual instances of digital identifiers 430 issued to a user 402. In various embodiments, this digital card individual data may include personal identification and associated digital card license data, such as that described in the descriptive text associated with FIG. 2 and FIG. 3. In these various embodiments, the digital identifier system 150 may access the data stored in the repositories of digital identifier template data 422 and digital identifier data 424 to generate a digital identifier 430. The method by which the digital identifier system 150 accesses the data stored in the repositories of digital identifier template data 422 and digital identifier data 424 in these embodiments is a matter of design choice.

In this embodiment, a user 402 uses a mobile device 404 to access the digital card license system 150 to request the issuance of a digital identifier 430. As used herein a mobile device 404 refers to wireless devices such as mobile telephones, smart phones, personal digital assistants (PDAs), tablet computers, handheld or laptop computers, and similar devices that have telecommunications capabilities. In various embodiments, the mobile device 404 is used to exchange information between a user 402 and the digital license system 150 through the use of a network 128. In various embodiments, the network 128 may be a public network, such as the Internet, a physical private network, a virtual private network (VPN), or any combination thereof.

In certain embodiments, the network 128 may be a wireless network, including a personal area network (PAN), based on technologies such as Bluetooth or Ultra Wideband (UWB). In various embodiments, the wireless network may include a wireless local area network (WLAN), based on variations of the IEEE 802.11 specification, often referred to as WiFi. In certain embodiments, the wireless network may include a wireless wide area network (WWAN) based on an industry standard including two and a half generation (2.5G) wireless technologies such as global system for mobile communications (GPRS) and enhanced data rates for GSM evolution (EDGE). In various embodiments, the wireless network may include WWANs based on existing third generation (3G) wireless technologies including universal mobile telecommunications system (UMTS) and wideband code division multiple access (W-CDMA). Other embodiments may include the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies. Skilled practitioners of the art will realize that many such embodiments are possible and the foregoing is not intended to limit the spirit, scope or intent of the invention.

Once the user 402 accesses the digital identifier system 150, they are provided a selection of digital identifier templates by a digital card license service. In various embodiments, the digital identifier service is implemented in the form of a servlet familiar to those of skill in the art. As an example, in one embodiment, the DigitalIdentifierServlet used in the following example references various digital identifier template configuration files, such as amtrak.conf.xml and ncfishing.conf.xml:

<!-- DigitalIdentifierServlet for Templates AMTRAK and FISHING-->

<servlet>

<servlet-class>com.ibm. DigitalIdentifier.demo.

DigitalIdentifierService. DigitalIdentifierServlet</servlet-class>

<servlet-name>digitalIdentifierServlet</servlet-name>
<init-param>

<param-name>amtrak</param-name>
<param-value>resource/amtrak/dml-amtrak.conf.xml</param-

value>

</init-param>
<init-param>

<param-name>fishing</param-name>
<param-value>resource/ncfishing/dml-

ncfishing.conf.xml</param-value>

</init-param>
<load-on-startup>1</load-on-startup>

</servlet>

<!-- HTTP POST for createImage service-->

<servlet-mapping>

<servlet-name>DigitalIdentifierServlet</servlet-name>
<url-pattern>/DigitalIdentifierService/createImage</url-pattern>

</servlet-mapping>

In various embodiments, the various digital identifier template configuration files are stored in a directory to facilitate their management. In certain of these embodiments, the various identifier template configuration files stored in the directory are loaded at the same time. For example, a directory named “publish” may contain subdirectories named “fishbrand0,” “fishbrand1,” “Amtrak,” “NCDMVFront,” “NCDMVBack,” and so forth.

In this embodiment, the two digital identifier templates displayed to the user 402 will be the privately-issued digital identifier template 202 shown in FIG. 2 and the government-issued digital identifier template 302 shown in FIG. 3. In various embodiments, the background images 204, 304 respectively associated with the digital identifier templates 202 and 302 shown in FIG. 2 and FIG. 3 are displayed to the user 402. The user 402 then selects the digital card license template, or background image, associated with the digital identifier 430 they wish to request. In response, the LicenseCardServlet is called to initiate the generation of the requested digital identifier 430. In this embodiment, the LicenseCardServlet is a Representational State Transfer (REST) Application Program Interface (API) that has four param for POSTing data:

LicenseCardService createImage

| Param | value | Discussion |
|---|---|---|
| cappicture | Base64 image | optional |
| signature | SVG data | optional |
| template | Symbolic name | needed |
| mime | html | Optional default return base64 image data |
| | | otherwise return a base64 HTML img tag |
| | | line. |

In this embodiment, any other params are assumed to be text fields that are defined in the associated digital identifier template configuration file (e.g., amtrak.conf.xml). As used herein, POST refers to a request method supported by the HTTP protocol, which is designed to request that a web server accept data enclosed in a request message's body for storage.

The user 402 is then prompted to provide authentication credentials, such as a user ID and password, familiar to skilled practitioners of the art. The method by which the user 402 is authenticated is a matter of design choice. Once authenticated, the user is prompted to provide a user image and personal identification information. In various embodiments, the user image and personal identification information is provided within a User Interface (UI) window 410 implemented on the mobile device. In certain embodiments, the image information includes a digitized photographic image 412 of the user. In one embodiment, the digitized photographic image 412 of the user 402 is obtained through the use of a camera in the mobile device 404. In another embodiment, the digitized photographic image 412 is a previously-obtained photographic image that is stored in a repository user images and other data 406 associated with the mobile device 404 of the user 402. In yet another embodiment, the digitized photographic image 412 is stored in the repository of digital card individual data 424. For example, an issuing organization may have an authenticated photographic image 412 of the user 402 that is mandated to be used for associated instances of digital identifier 430. In this embodiment, the method by which the digitized photographic image 412 is retrieved from the repository of digital card individual data 424 is a matter of design choice. Once the digitized photographic image 412 has been provided by the user 401, it is added to the UI window 410 by selecting the “Add Photo” command button 414 with a user gesture, such as the tap of a fingertip on the screen of the mobile device 404.

In various embodiments, the user identification information includes a digitized signature 416 of the user 402. In certain embodiments, the digitized signature 416 of the user 402 is entered in the UI window 410 by the user 402 using their finger or a stylus to create the signature. In one embodiment, a digitized image of the signature 416 of the user 402 is stored in the repository of digital card individual data 424. For example, an issuing organization may have an authenticated signature 416 of the user 416 that is mandated to be used on the digital identifier 430. In this embodiment, the method by which the authenticated signature 416 of the user 402 is retrieved from the repository of digital card individual data 424 is a matter of design choice. The user 402 then selects the “Send” command button 418 within the UI window 410 of the mobile device 404 to POST their photographic image 412, and the digitized signature 416, to the digital identifier system 150.

As a result, the following POST params are provided to the CardServiceServlet:

| Param | value | Discussion |
|---|---|---|
| cappicture | Base64 image | optional |
| signature | SVG data | optional |
| brand | amtrak | needed |
| status | text | Field on card |
| location | text | Field on card |
| name | text | Field on card |

In response, the digital identifier system 150 processes the received information with the previously selected digital identifier template to generate an associated instance of a digital identifier 430, which in turn is provided to the user 402. In various embodiments, the associated instance of the digital identifier 430 is provided to the mobile device 404 of the user 402. In certain embodiments, a PERL script familiar to skilled practitioners of the art is implemented to generate the associated instance of the digital identifier 430. Those of skill in the art will recognize that many such embodiments are possible and the foregoing is not intended to limit the spirit, scope or intent of the invention.

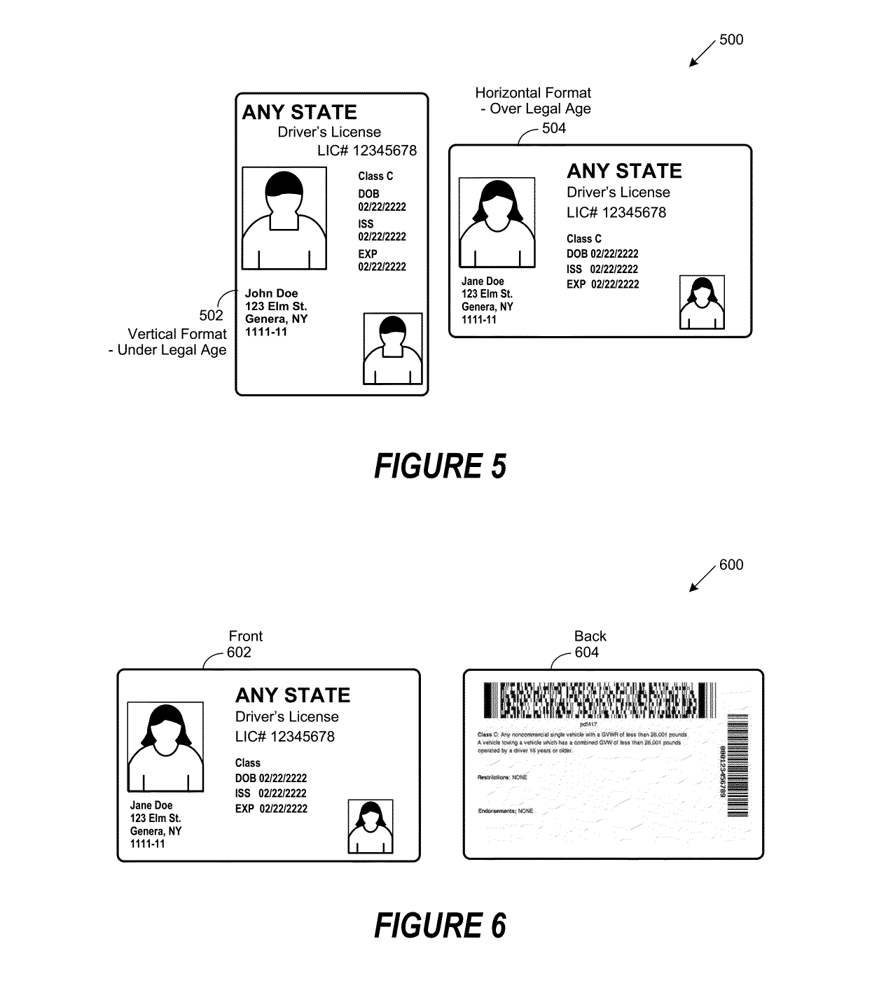

FIG. 5 shows vertical and horizontal formats of a government-issued digital identifier implemented in accordance with an embodiment of the invention. In various embodiments, a digital identifier 500 is issued by a government agency or organization in either a vertical or horizontal aspect, dependent upon certain predetermined information associated with an individual. As an example, certain states in the U.S. use a vertical format when issuing a driver's license to more clearly indicate that the individual may likely be underage.

In this embodiment, the POST HTML code shown below is implemented to generate associated instances of a government-issued digital license 500 in either a vertical format 502 or horizontal format 504. As shown, the LicenseFormatServlet looks up the age of the individual and calls the appropriate digital identifier format component:

<!-- IdentifierFormatServlet for Identifier CardDOCTYPE html -->
<servlet>

<servlet-
class>com.ibm.identifierformatservice.IdentifierFormatServlet</servlet-
class>
<servlet-name><IdentifierFormatServlet</servlet-name>
<init-param>

<init-param>ncdmv</param-name>
<pram-value>resource/gdmv/dml-ncdmv.conf.xml</param-

value>
<init-param>
<init-param>

<init-param>ncdmvkid</param-name>
<pram-value>resource/gdmv/dml-ncdmvkid.conf.xml</param-

value>
<init-param>
<load-on-startup>1</load-on-startup>

<servlet>

FIG. 6 shows the front and back aspects of a two-sided, government-issued digital identifier implemented in accordance with an embodiment of the invention. In various embodiments, a digital identifier 600 is issued by a government agency or organization with both front and back aspects, each of which displays predetermined information associated with an individual. As an example, certain states in the U.S. use one or more bar codes on the back of a driver's license to contain information that can be scanned into various systems.

In this embodiment, the POST HTML code shown below is implemented to generate associated instances of a two-sided, government-issued digital license 600 with either a front aspect 502 or back aspect 504. As shown, the LicenseFormatServlet receives a request for the front, back, or both aspects of a two-sided, government-issued digital identifier and calls the appropriate digital identifier format component:

<!-- IdentifierAspectServlet for Identifier CardDOCTYPE html -->
<servlet>

<servlet-
class>com.ibm.identifieraspectservice.IdentifierAspectServlet</servlet-
class>
<servlet-name><IdentifierAspectServlet</servlet-name>
<init-param>

<param-name>dmvback</param-name>
<pram-value>resource/gdmv/dml-back.conf.xml</param-value>

<init-param>
<init-param>

<param-name>dmvfront</param-name>
<pram-value>resource/gdmv/dml-front.conf.xml</param-value>

<init-param>
<load-on-startup>1</load-on-startup>

<servlet>

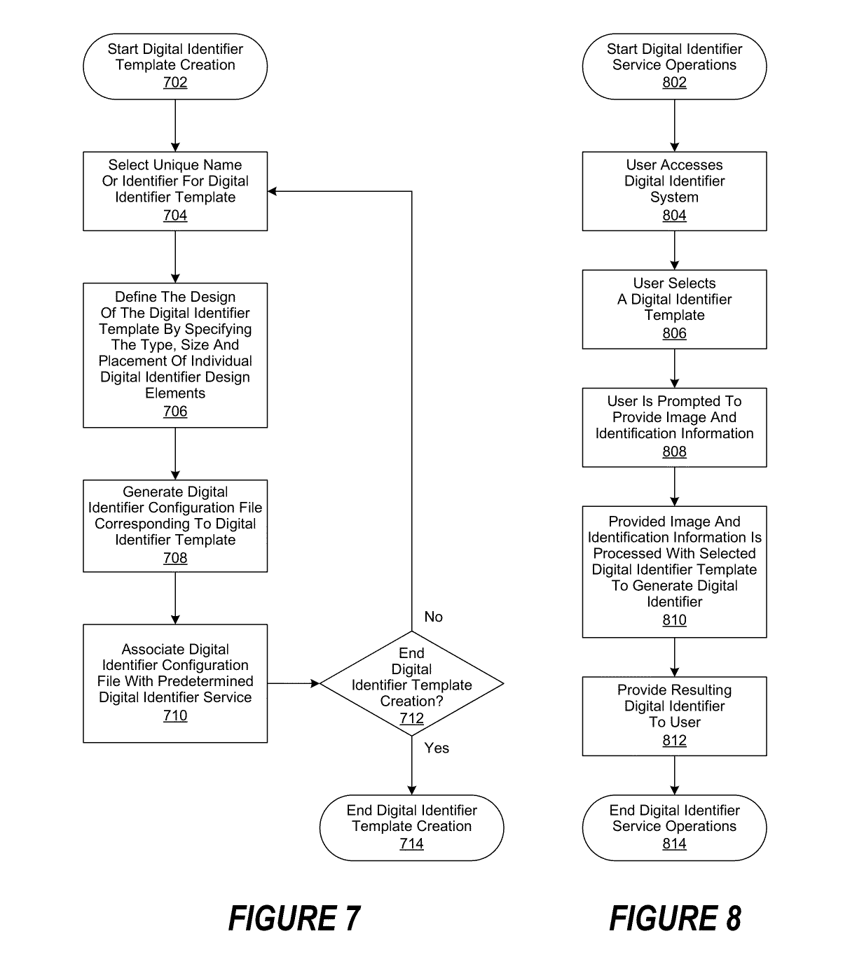

FIG. 7 is a generalized flowchart of operations performed in accordance of an embodiment of the invention to create a digital identifier template. In this embodiment, digital identifier template creation operations are begun in step 702, followed by the selection of a unique name or identifier for a digital license template in step 704. The design of the digital identifier template is then defined by specifying the type, size, and placement of individual digital identifier design elements in step 706. In various embodiments, the digital identifier elements may include textual elements, graphical elements, or a combination thereof, as described in greater detail herein. Then, as likewise described in greater detail herein, a digital identifier configuration file corresponding to the digital identifier template is generated in step 708.

The resulting digital license configuration file is then associated with a predetermined digital identifier service in step 710. The method by which the predetermined digital identifier service is selected, and the method by which it is associated with the digital license configuration file, is a matter of design choice. A determination is then made in step 712 whether to end digital identifier service operations. If not, then the process is continued, proceeding with step 704. Otherwise, digital identifier template creation operations are ended in step 714.

FIG. 8 is a generalized flowchart of digital identifier service operations performed in accordance of an embodiment of the invention. In this embodiment, digital identifier service operations are begun in step 802, followed by a user accessing a digital identifier system in step 804. The user is then selects a target digital identifier template or background image in step 806, followed by being prompted in step 806 to provide predetermined image and personal identification information, as described in greater detail herein, in step 808. The provided image and personal identification information is then processed in step 810, as likewise described in greater detail herein, with a corresponding digital identifier template, to generate an associated instance of a digital identifier. In turn, the associated instance of the digital identifier is then provided to the user in step 812. The method by which associated instance of the digital identifier is provided to the user is a matter of design choice. Digital identifier service operations are then ended in step 814.

Although the present invention has been described in detail, it should be understood that various changes, substitutions and alterations can be made hereto without departing from the spirit and scope of the invention as defined by the appended claims.

What is claimed is:

1. A computer-implemented method for producing a digital identifier, comprising:
responsive to user input, selecting a set of design elements for inclusion in the digital identifier;
responsive to user input, selecting a template for placement of the design elements within the digital identifier, the template comprising a template name;
responsive to user input, selecting a set of user credentials for inclusion in the digital identifier; and
using the selected design elements, template and user credentials to produce the digital identifier.

2. The method of claim 1, wherein the set of design elements comprises at least one member of the set of:
a set of graphical design elements; and
a set of textual design elements.

3. The method of claim 2, wherein the set of graphical design elements comprises at least one member of the set of:
a digitized photograph of an individual associated with the digital identifier;
a digitized signature of an individual associated with the digital identifier;
a digitized glyph;
a digitized barcode;
a digitized security guilloche; and
a digitized background image.

4. The method of claim 3, wherein one of the set of graphical design elements is captured by a user device.

5. The method of claim 2, wherein the set of textual design elements comprises at least one member of the set of:
the name of the individual;
the address of the individual;
the member status of the individual;
the employee identifier (ID) of the individual;
the issuance date of the digital identifier;
the issuance time of the digital identifier;
the expiry date of the digital identifier; and
a list of privileges associated with the individual.

6. The method of claim 1, wherein at least one of the digital identifier design elements is secured to prevent unauthorized access to the digital identifier.

7. A system comprising:
a processor;
a data bus coupled to the processor; and
a computer-usable medium embodying computer program code, the computer-usable medium being coupled to the data bus, the computer program code used for producing a digital identifier and comprising instructions executable by the processor and configured for:
responsive to user input, selecting a set of design elements for inclusion in the digital identifier;
responsive to user input, selecting a template for placement of the design elements within the digital identifier, the template comprising a template name;
responsive to user input, selecting a set of user credentials for inclusion in the digital identifier; and
using the selected design elements, template and user credentials to produce the digital identifier.

8. The system of claim 7, wherein the set of design elements comprises at least one member of the set of:
a set of graphical design elements; and
a set of textual design elements.

9. The system of claim 8, wherein the set of graphical design elements comprises at least one member of the set of:
a digitized photograph of an individual associated with the digital identifier;
a digitized signature of an individual associated with the digital identifier;
a digitized glyph;
a digitized barcode;
a digitized security guilloche; and
a digitized background image.

10. The system of claim 9, wherein one of the set of graphical design elements is captured by a user device.

11. The system of claim 8, wherein the set of textual design elements comprises at least one member of the set of:
the name of the individual;
the address of the individual;
the member status of the individual;
the employee identifier (ID) of the individual;
the issuance date of the digital identifier;
the issuance time of the digital identifier;
the expiry date of the digital identifier; and
a list of privileges associated with the individual.

12. The system of claim 7, wherein:
at least one of the digital identifier design elements is secure to prevent unauthorized access to the digital identifier.

13. A non-transitory, computer-readable storage medium embodying computer program code, the computer program code comprising computer executable instructions configured for:
responsive to user input, selecting a set of design elements for inclusion in the digital identifier;
responsive to user input, selecting a template for placement of the design elements within the digital identifier, the template comprising a template name;
responsive to user input, selecting a set of user credentials for inclusion in the digital identifier; and
using the selected design elements, template and user credentials to produce the digital identifier.

14. The non-transitory, computer-readable storage medium of claim 13, wherein the set of design elements comprises at least one member of the set of:
a set of graphical design elements; and
a set of textual design elements.

15. The non-transitory, computer-readable storage medium of claim 14, wherein the set of graphical design elements comprises at least one member of the set of:
a digitized photograph of an individual associated with the digital identifier;
a digitized signature of an individual associated with the digital identifier;
a digitized glyph;
a digitized barcode;
a digitized security guilloche; and
a digitized background image.

16. The non-transitory, computer-readable storage medium of claim 15, wherein one of the set of graphical design elements is captured by a user device.

17. The non-transitory, computer-readable storage medium of claim 14, wherein the set of textual design elements comprises at least one member of the set of:
the name of the individual;
the address of the individual;
the member status of the individual;
the employee identifier (ID) of the individual;
the issuance date of the digital identifier;
the issuance time of the digital identifier;
the expiry date of the digital identifier; and
a list of privileges associated with the individual.

18. The non-transitory, computer-readable storage medium of claim 13, wherein:
at least one of the digital identifier design element is secured to prevent unauthorized access to the digital identifier.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
